(19) United States
(12) Patent Application Publication
(10) Pub. No.: US 2012/0198254 A1
(43) Pub. Date: Aug. 2, 2012

(54) CAPPING POWER CONSUMPTION IN A DATA STORAGE SYSTEM

(75) Inventors: Miriam Allalouf, Haifa (IL); Ronen Itshak Kat, Haifa (IL); Kalman Z. Meth, Haifa (IL)

(73) Assignee: International Business Machines Corporation, Armonk, NY (US)

(21) Appl. No.: 13/430,733

(22) Filed: Mar. 27, 2012

Related U.S. Application Data
(62) Division of application No. 12/494,282, filed on Jun. 30, 2009.

(51) Int. Cl. G06F 1/32; G06F 1/26

(52) U.S. Cl. 713/320; 713/300

(57) ABSTRACT

A method for capping power consumption in a data storage system is provided. The method comprises associating a power quota with a first storage medium, wherein the power quota limits amount of power consumed by the first storage medium within a given time interval; receiving a request to perform an input/output (I/O) operation on the first storage medium; and servicing the request within power limits defined by the power quota.

### CROSS-REFERENCE TO RELATED APPLICATIONS

This application is a divisional of, and claims priority to, U.S. application Ser. No. 12/494,282, filed on 2009 Jun. 30, the content of which is incorporated herein by reference in entirety.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The claimed subject matter relates generally to data storage systems and, more particularly, to capping power consumption in a data storage system.

### BACKGROUND

Power consumption of certain components in a computing environment may be capped under certain conditions. For example, a processor may throttle input/output (I/O) operations in response to detecting that the power consumption of the processor is about to exceed a certain threshold. That is, the processer may delay the I/O operations by scheduling the I/O operations to be serviced at a later time. Alternatively, the processor may enter a different power mode (e.g., an idle mode) to maintain power consumption at a certain level.

Unfortunately, current power management methods are not viable for capping power consumption of storage media in a data storage system. Storage media generally do not include a means for monitoring power consumption, and I/O operations with the same I/O rate may consume different amounts of power. Thus, it is difficult to detect power consumption of components in a storage system for the purpose of managing the system's consumption level. Additionally, entering a low power mode (e.g., standby mode) from a high power mode or vice versa requires a long transition period that is unacceptable in most storage systems.

Systems and methods are needed to overcome the above-mentioned shortcomings.

### SUMMARY

The present disclosure is directed to systems and corresponding methods that facilitate capping power consumption in a data storage system.

For purposes of summarizing, certain aspects, advantages, and novel features have been described herein. It is to be understood that not all such advantages may be achieved in accordance with any one particular embodiment. Thus, the claimed subject matter may be embodied or carried out in a manner that achieves or optimizes one advantage or group of advantages without achieving all advantages as may be taught or suggested herein.

In accordance with one embodiment, a method for capping power consumption in a data storage system is provided. The method comprises associating a power quota with a first storage medium, wherein the power quota limits amount of power consumed by the first storage medium within a given time interval; receiving a request to perform an input/output (I/O) operation on the first storage medium; and servicing the request within power limits defined by the power quota.

In accordance with another embodiment, a system comprising one or more logic units is provided. The one or more logic units are configured to perform the functions and operations associated with the above-disclosed methods. In accordance with yet another embodiment, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary data storage system, in accordance with one or more embodiments.

FIG. 2 is a flow diagram of a method for capping power consumption according to a power quota, in accordance with one embodiment.

FIG. 3 is a flow diagram of a method for capping power consumption according to a power quota and one or more performance parameters, in accordance with one embodiment.

FIG. 4 is a flow diagram of a method of utilizing a token bucket mechanism to cap power consumption according to a power quota, in accordance with one embodiment.

FIG. 5 is a flow diagram of a method for utilizing a token bucket mechanism to determine compliance with a performance parameter, in accordance with one embodiment.

FIG. 6 is a flow diagram of a method for utilizing a token bucket mechanism to cap power consumption according to a power quota and one or more performance parameters, in accordance with one embodiment.

FIGS. 7 and 8 are block diagrams of hardware and software environments in which a system of the present invention may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXEMPLARY EMBODIMENTS

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the claimed subject matter. The level of detail associated with each of the elements or features should not be construed to qualify the novelty or importance of one feature over the others.

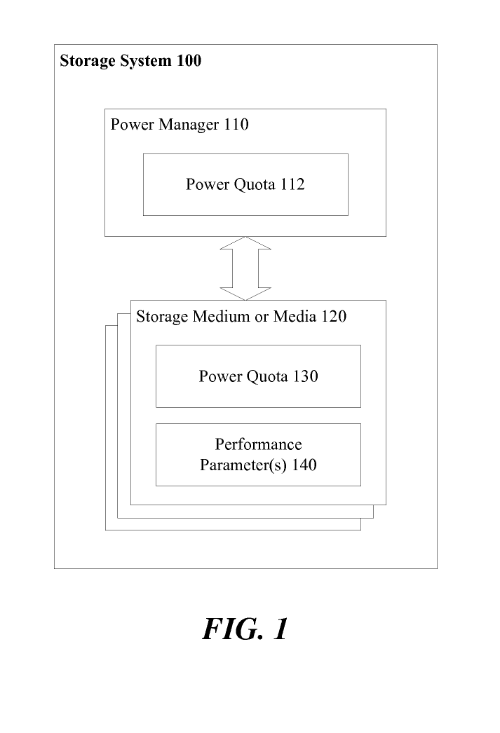

Referring to FIG. 1, in accordance with one embodiment, an exemplary data storage system 100 comprises a power manager 110 and one or more storage media 120. The storage media 120 may comprise storage devices such as disk drives, solid-state devices, or optical devices. The storage system 100 may be configured as but is not limited to a redundant array of independent disks (RAID) such that each of the storage media 120 comprises an array with multiple storage devices. The power manager 110 may be embedded in the I/O path of any computing system (not shown) with access to the storage system 100 or in the I/O path of the storage system 100.

For example, the power manager 110 may be included in a storage controller and be associated with a power quota 112. The power quota 112 defines the maximum amount of power that may be collectively consumed by the storage media 120 within a given time interval. The power manager 110 may divide the power quota 112 among the storage media 120 by associating each storage medium 120 with a power quota 130. The power quota 130 defines the maximum amount of power that may be consumed by the storage medium 120 within a given time interval. Depending on implementation, the given time interval may be a fixed-length or adjustable time period.

Each of the storage media 120 may also be associated with one or more performance parameters 140. The performance parameters 140 may be defined in a performance profile, which indicates whether the storage medium 120 is in compliance with the performance parameters 140. The storage medium 120 is in compliance with a performance parameter 140 if the storage medium 120 performs an I/O operation within the performance parameter 140.

In one implementation, the power manager 110 may utilize the performance profile to determine if adjusting the power quota 130 causes the storage medium 120 to violate a performance parameter 140. In addition, the power manager 110 may utilize the performance profile to determine if adjusting a performance parameter 140 causes the storage medium 120 to violate the power quota 130.

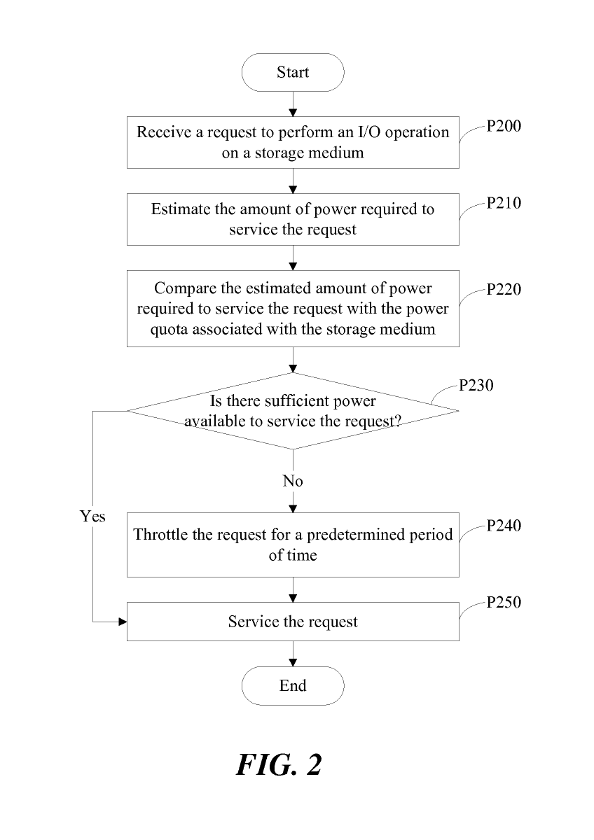

Referring to FIGS. 1 and 2, in accordance with one embodiment, the power manager 110 may cap power consumption according to a power quota 130 associated with a storage medium 120. The power manager 110 receives a request to perform an I/O operation on the storage medium 120 (P200).

The request may indicate the type of the I/O operation (e.g., a read operation, a write operation, a sequential operation, a random operation, or a combination thereof) using a tagging mechanism, for example. If the storage medium 120 comprises a disk array, the request may indicate the RAID type and the number of disk drives in the disk array, for example.

Upon receiving the request, the power manager 110 estimates the amount of power required to service the request (P210). The estimated amount of power may depend on the type of the I/O operation and the number of requests directed to the storage medium 120 within a given time interval.

A sequential I/O operation on a disk drive may consume less power than a random I/O operation because a sequential I/O operation requires less seek time (i.e., time to move the head of a disk drive between locations), for example. Additionally, if there are a large number of requests received within the given time interval, the power manager 110 may queue and reorder the requests to reduce seek times, thereby reducing power consumption, for example.

Upon estimating the amount of power required to service the request, the power manager 110 compares the estimated amount of power required to service the request to the power quota 130 associated with the storage medium 120 (P220) to determine whether there is sufficient power available to service the request (P230). If there is insufficient power available, the power manager 110 throttles, or delays, the request for a predetermined period of time (e.g., until the next time interval) (P240). Otherwise, the power manager 110 directly services the request (P250).

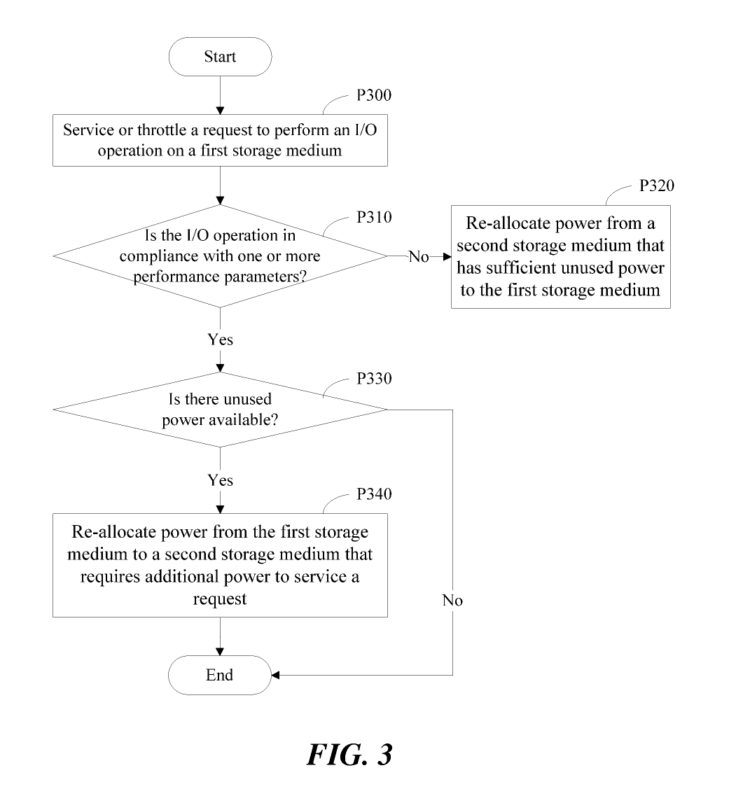

Servicing or throttling a request may violate a performance parameter that requires the request to be serviced within a certain time period. Referring to FIG. 3, in accordance with one embodiment, the power manager 110 may cap power consumption according to a power quota 130 and one or more performance parameters 140 associated with a first storage medium 120.

Upon servicing or throttling a request to perform an I/O operation on a first storage medium 120 (P300), the power manager 110 determines whether the first storage medium 120 is in compliance with the performance parameters 140 (P310). In one implementation, the first storage medium 120 may determine compliance with the performance parameters 140 using a performance profile, as provided earlier.

Upon detecting a performance violation, the power manager 110 enables the first storage medium 120 to consume an amount of power that exceeds its own power quota 130 at the expense of a second storage medium 120 that has sufficient unused power available (P320). If the first storage medium 120 is in compliance with the performance parameters 140 and within its power quota 130 (P330), the power manager 110 may allocate unused power to a second storage medium 120 that requires additional power to service a request at the expense of the first storage medium 120 (P340).

In other words, the power manager 110 may re-allocate unused power from the first storage medium 120 to a second storage medium 120 or vice versa. This re-allocation of unused power may prevent further performance violations associated with the first storage medium 120 or the second storage medium 120, respectively.

In one or more implementations, the power manager 110 may re-allocate unused power by adjusting (i.e., increasing or decreasing) the power quota 130 associated with a storage medium 120. Depending on implementation, the adjustments to the power quota 130 may be permanent or temporary. In addition, re-allocation of unused power may be performed in a fair manner that avoids starvation using class-based queuing (CBQ), deficit round robin (DRR), or other scheduling policies.

A token bucket mechanism may be utilized to control network traffic (i.e., the amount of data injected into a network). In one implementation, one or more tokens, each representing a byte of data, are added to a bucket at the beginning of a given time interval. In response to receiving a request to inject n bytes of data into the network, a network controller determines whether there are at least n tokens in the bucket. If so, the network controller removes n tokens from the bucket and injects the n bytes of data into the network. Otherwise, the network controller discards the request.

The token bucket mechanism may be modified to implement a power quota 130 associated with a storage medium 120, such that each token represents a certain amount of power or energy (e.g., in watts or joules). In such an implementation, the power quota 130 may be adjusted by increasing or decreasing the number of tokens added to a power bucket implemented for the power quota 130 per time interval or by increasing or decreasing the length of the time interval.

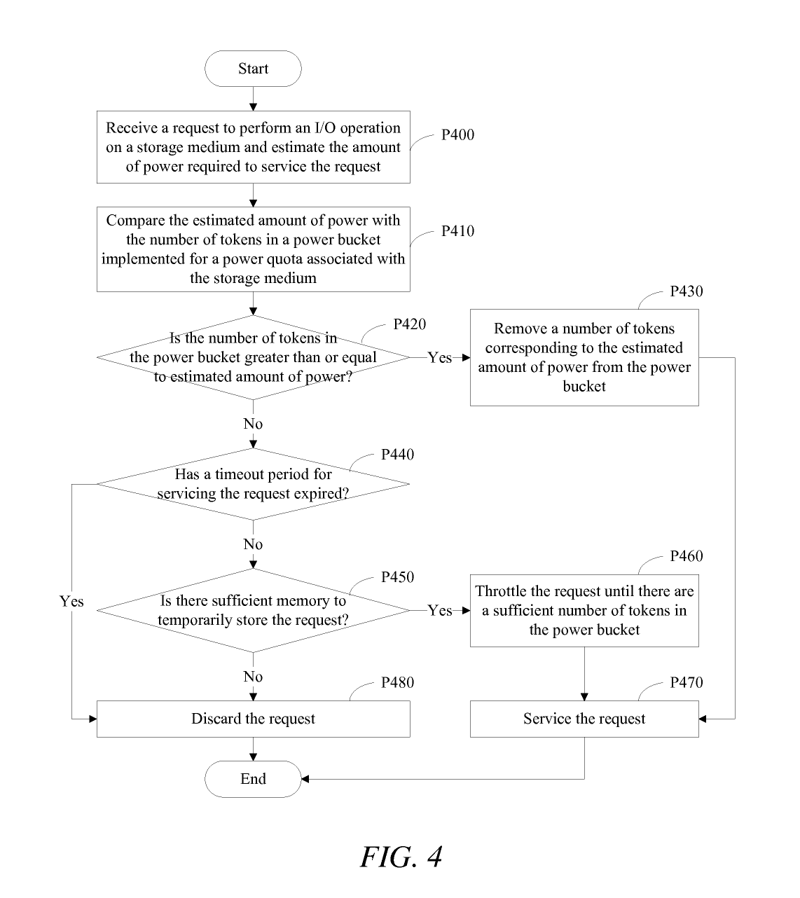

Referring to FIGS. 1 and 4, in accordance with one embodiment, the power manager 110 may utilize a token bucket mechanism to cap power consumption according to a power quota 130 associated with a storage medium 120. The power manager 110 receives a request to perform an I/O operation on a storage medium 120 and estimates the amount of power required to service the request (P400).

The power manager 110 determines whether there is sufficient power available to service the request according to the power quota 130 associated with the storage medium 120 by comparing the estimated amount of power with the number of tokens in a power bucket implemented for the power quota 130 associated with the storage medium 120 (P410). If the number of tokens in the power bucket is greater than or equal to the estimated amount of power (P420), the power manager 110 removes a number of tokens corresponding to the estimated amount of power from the power bucket (P430) and services the request (P470).

Otherwise, the power manager 110 determines whether a timeout period for servicing the request, if any, has expired (P440). If there is no timeout period or the timeout period has not expired, the power manager 110 determines whether there is sufficient memory to temporarily store the request (P450). If there is sufficient memory, the power manager 110 throttles the request until at least a number of tokens corresponding to the estimated amount of power are in the power bucket (P460). Otherwise, the power manager 110 discards the request (P480).

The token bucket mechanism may also be configured to enforce a performance parameter 140 associated with a storage medium 120, such that a performance bucket is implemented for each performance parameter 140 associated with the storage medium 120. Performance buckets allow the power manager 110 to monitor the storage medium 120's compliance with one or more performance parameters 140 (e.g., time required to service a request) associated with the storage medium 120.

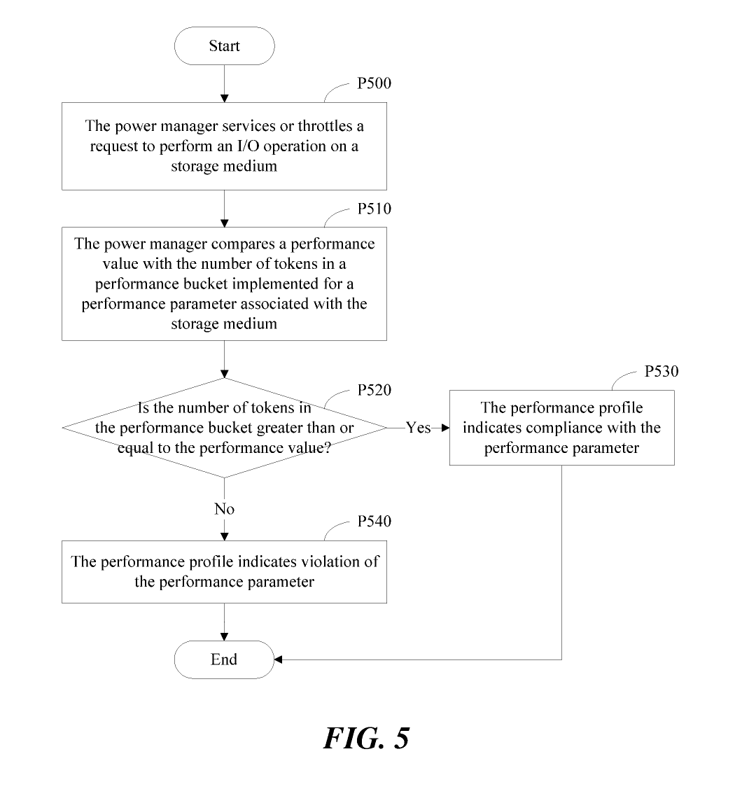

Referring to FIGS. 1 and 5, in accordance with one embodiment, the power manager 110 may utilize a token bucket mechanism and a performance profile to determine a storage medium 120's compliance with a performance parameter 140.

Upon servicing or throttling a request to perform an I/O operation on the storage medium 120 (P500), the power manager 110 compares a performance value related to the performance parameter 140 to the number of tokens in a performance bucket implemented for the performance parameter 140 (P510). For example, if the performance parameter 140 requires that the power manager 110 service the request within a certain time period, the performance value may be the number of seconds taken to service the request (i.e., the response time).

If the number of tokens in the performance bucket is greater than or equal to the performance value (P520), a performance profile indicates that the storage medium 120 is in compliance with the performance parameter 140 (P530). Otherwise, the performance profile indicates that the storage medium 120 is in violation of the performance parameter 140 (P540).

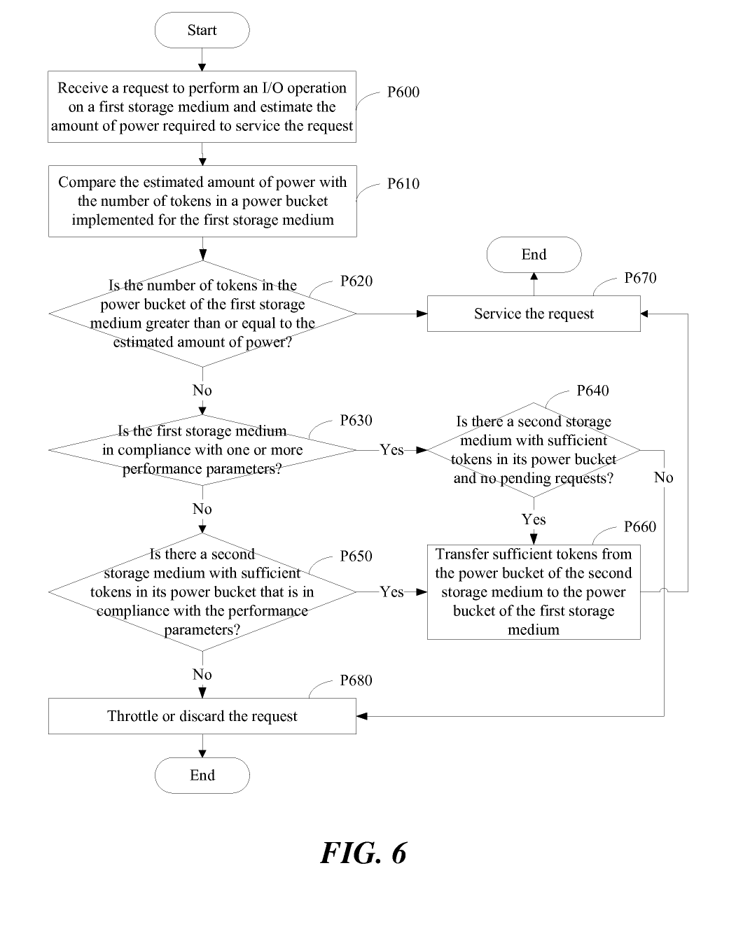

Referring to FIGS. 1 and 6, in accordance with one embodiment, the power manager 110 may utilize a token bucket mechanism to cap power consumption according to a power quota 130 and one or more performance parameters associated with a first storage medium 120. Upon receiving a request to perform an I/O operation on the first storage medium 120, the power manager 110 estimates the amount of power required to service the request (P600).

Upon estimating the amount of power required to service the request, the power manager 110 compares the estimated amount of power to the number of tokens in the power bucket implemented for the first storage medium 120 (P610). If the number of tokens in the power bucket is greater than or equal to the estimated amount of power (P620), the power manager 110 services the request (P670).

If the number of tokens in the power bucket is less than the estimated amount of power (P620) and the first storage medium 120 is in compliance with the performance parameters 140 (P630), the power manager 110 determines whether there is a second storage medium 120 with a sufficient number of tokens in its power bucket and no pending requests (P640).

If there is such a second storage medium 120, the power manager 110 transfers the sufficient number of tokens from the power bucket of the second storage medium 120 to the power bucket of the first storage medium 120 (P660). Once the tokens are transferred, the power manager 110 services the request (P670). If such a second storage medium 120 does not exist, the power manager 110 throttles or discards the request (P680).

If the number of tokens in the power bucket is less than the estimated amount of power (P620) and the first storage medium is not in compliance with the performance parameters 140 (P630), the power manager 110 determines whether there is a second storage medium 120 with a sufficient number of tokens in its power bucket that is in compliance with the performance parameters 140 (P650).

If there is such a second storage medium 120, the power manager 110 transfers the sufficient number of tokens from the power bucket of the second storage medium 120 to the power bucket of the first storage medium 120 (P660). Once the tokens are transferred, the power manager 110 services the request (P670). If such a second storage medium 120 does not exist, the power manager 110 throttles or discards the request (P680).

In different embodiments, the claimed subject matter may be implemented either entirely in the form of hardware or entirely in the form of software, or a combination of both hardware and software elements. For example, the storage system 100 may be included in a controlled computing system environment that can be presented largely in terms of hardware components and software code executed to perform processes that achieve the results contemplated by the system of the present invention.

Referring to FIGS. 1, 7, and 8, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. In one embodiment, the power manager 110 may be implemented as system software 1121 or application software 1122 executed on one or more hardware environments to cap power consumption in the storage system 100.

System software 1121 may comprise control programs, such as the operating system (OS) and information management systems that instruct the hardware how to function and process information. Application software 1122 may comprise but is not limited to program code, data structures, firmware, resident software, microcode or any other form of information or routine that may be read, analyzed or executed by a microcontroller.

In an alternative embodiment, the claimed subject matter may be implemented as a computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate or transport the program for use by or in connection with the instruction execution system, apparatus or device.

The computer-readable medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

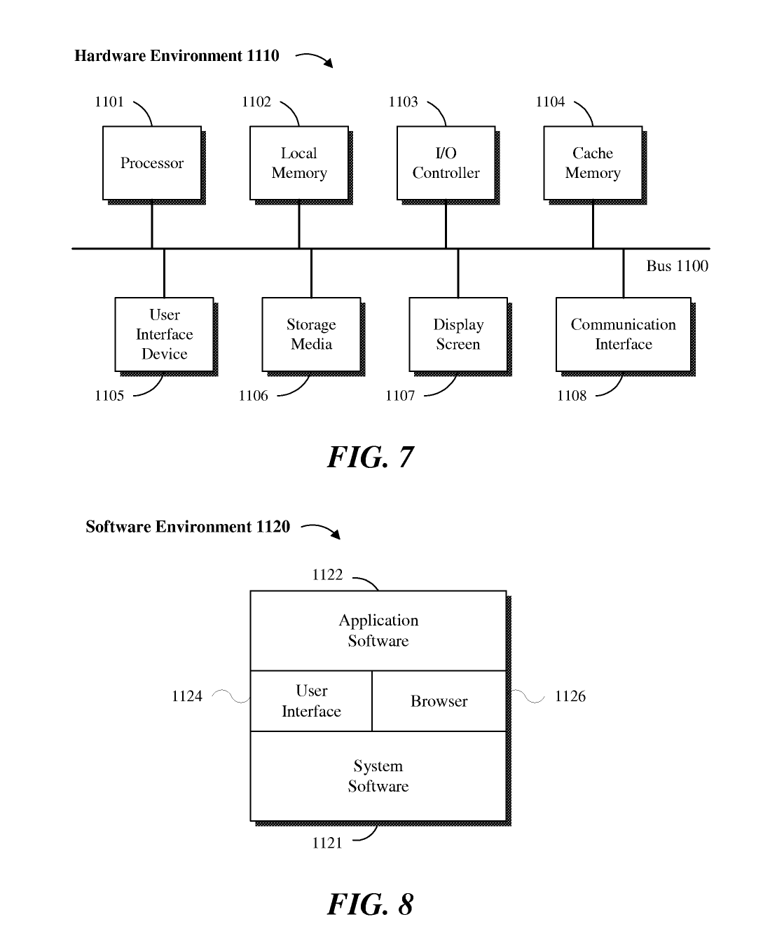

Referring to FIG. 7, an embodiment of the application software 1122 may be implemented as computer software in the form of computer readable code executed on a data processing system such as hardware environment 1110 that comprises a processor 1101 coupled to one or more memory elements by way of a system bus 1100. The memory elements, for example, may comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 8, application software 1122 may comprise one or more computer programs that are executed on top of system software 1121 after being loaded from storage media 1106 into local memory 1102. In a client-server architecture, application software 1122 may comprise client software and server software. For example, in one embodiment, client software is executed on a general computer (not shown) and server software is executed on a server system (not shown).

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The claimed subject matter has been described above with reference to one or more features or embodiments. Those skilled in the art will recognize, however, that changes and modifications may be made to these embodiments without departing from the scope of the claimed subject matter. These and various other adaptations and combinations of the embodiments disclosed are within the scope of the claimed subject matter as defined by the claims and their full scope of equivalents.

What is claimed is:

1. A method of capping power consumption in a data storage system, the method comprising:
receiving a request to perform an input/output (I/O) operation on the first storage medium;
estimating amount of power required to service the request;
comparing the estimated amount of power required to service the request with a maximum power limit defined by a power quota associated with the first storage medium; and
using power allocated to a second storage medium to service the request, in response to determining that the estimated amount of power required to service the request is approximately greater than the maximum power limit defined by the power quota.

2. The method of claim 1, wherein the second storage medium has sufficient power available to service the request and is in compliance with a first performance parameter associated with the first storage medium.

3. The method of claim 1, wherein the second storage medium has sufficient power available to service the request and no pending requests.

4. The method of claim 1, wherein the estimating is performed according to type of the I/O operation.

5. The method of claim 1, wherein the estimating is performed according to number of requests directed to the first storage medium within the given time interval.

6. The method of claim 1, wherein the request is serviced, in response to determining that the estimated amount of power required to service the request is approximately less than or equal to the maximum power limit defined by the power quota.

7. The method of claim 1, wherein the request is throttled for a predetermined period of time, in response to determining that the estimated amount of power required to service the request is approximately greater than the maximum power limit defined by the power quota.

8. The method of claim 1, further comprising decreasing the power quota to reduce power consumption by the first storage medium.

9. The method of claim 1, wherein the power quota is implemented using a token bucket mechanism.

10. The method of claim 1, further comprising:
associating at least a first performance parameter with the first storage medium;
increasing the power quota to avoid violating the first performance parameter; and
re-allocating unused power to a second storage medium that is in violation of the first performance parameter.

11. A system for capping power consumption in a data storage system, the system comprising:
a logic unit for receiving a request to perform an input/output (I/O) operation on the first storage medium;
a logic unit for estimating amount of power required to service the request;
a logic unit for comparing the estimated amount of power required to service the request with a maximum power limit defined by a power quota associated with the first storage medium; and
a logic unit for using power allocated to a second storage medium to service the request, in response to determining that the estimated amount of power required to service the request is approximately greater than the maximum power limit defined by the power quota.

12. The system of claim 11, wherein the second storage medium has sufficient power available to service the request and is in compliance with a first performance parameter associated with the first storage medium.

13. The system of claim 11, wherein the second storage medium has sufficient power available to service the request and no pending requests.

14. The system of claim 11, wherein the estimating is performed according to type of the I/O operation.

15. The system of claim 11, wherein the estimating is performed according to number of requests directed to the first storage medium within the given time interval.

16. A computer program product comprising logic code embedded in a non-transitory data storage medium, wherein execution of the logic code on a machine causes the machine to:
cap power consumption in a data storage system comprising one or more processors, the system comprising:
receive a request to perform an input/output (I/O) operation on the first storage medium;
estimate amount of power required to service the request;
compare the estimated amount of power required to service the request with a maximum power limit defined by a power quota associated with the first storage medium; and
use power allocated to a second storage medium to service the request, in response to determining that the estimated amount of power required to service the request is approximately greater than the maximum power limit defined by the power quota.

17. The computer program product of claim 16, wherein the second storage medium has sufficient power available to service the request and is in compliance with a first performance parameter associated with the first storage medium.

18. The computer program product of claim 16, wherein the second storage medium has sufficient power available to service the request and no pending requests.

19. The computer program product of claim 16, wherein the estimating is performed according to type of the I/O operation.

20. The computer program product of claim 16, wherein the estimating is performed according to number of requests directed to the first storage medium within the given time interval.
